(19) United States
(12) Patent Application Publication
(10) Pub. No.: US 2026/0260886 A1
(43) Pub. Date: Sep. 3, 2026

(54) ELECTRODE, BATTERY, AND BATTERY PACK

(71) Applicant: KABUSHIKI KAISHA TOSHIBA, Kawasaki-shi (JP)

(72) Inventors: Masanori NAGASAKA, Yokohama Kanagawa (JP); Naoki NISHIO, Yokohama Kanagawa (JP); Takasumi SAITO, Yokohama Kanagawa (JP)

(73) Assignee: KABUSHIKI KAISHA TOSHIBA, Kawasaki-shi (JP)

(21) Appl. No.: 19/654,639

(22) Filed: Apr. 22, 2026

Related U.S. Application Data
(63) Continuation of application No. PCT/JP2024/033730, filed on Sep. 20, 2024.

(51) Int. Cl. H01M 4/525; H01M 4/02; H01M 4/131; H01M 4/505; H01M 4/62

(52) U.S. Cl. CPC H01M 4/525; H01M 4/131; H01M 4/505; H01M 4/625; H01M 2004/021

(57) ABSTRACT

According to one embodiment, provided is an electrode including a current collector and an active material-containing layer that contains an electro-conductive agent and an active material including a lithium nickel cobalt manganese composite oxide. For the active material-containing layer, a specific surface area S_{BET} according to nitrogen gas adsorption and a pore specific surface area S_{Hg} according to mercury intrusion satisfy a relationship of 0.8<S_{BET}/S_{Hg} <2.0. A volume resistivity R_{V} of the active material-containing layer is 10 Ω·cm or less. An interfacial resistance R_{I} of an interface between the current collector and the active material-containing layer is 0.5 Ω·cm² or less. A ratio R_{V}/R_{I} is 3 cm⁻¹ or more and 20 cm⁻¹ or less.

### CROSS-REFERENCE TO RELATED APPLICATION

This application is a Continuation Application of PCT Application No. PCT/JP2024/033730, filed Sep. 20, 2024, the entire contents of which are incorporated herein by reference.

### FIELD

Embodiments of the present invention relate to an electrode, battery, and battery pack.

### BACKGROUND

In recent years, secondary batteries, including nonaqueous electrolyte secondary batteries such as lithium ion secondary batteries, are anticipated in applications not only for electronic devices such as mobile phones but also for vehicles such as hybrid electric automobiles and electric automobiles, as well as, large systems such as electric aircrafts and power storage. Thus, improvement in large capacity performance, large current output performance, and long life performance are demanded on secondary batteries.

As the negative electrode active material of the nonaqueous electrolyte battery, graphite is generally used. When a graphite negative electrode is used, a battery having high output and high energy density can be obtained. A risk of precipitation of lithium dendrites due to, e.g., overvoltage is known for graphite negative electrodes. When the dendrites penetrate the separator, an internal short circuit occurs. In addition, in graphite, since expansion and contraction occurs along the c-axis direction according to Li insertion-extraction, the structural deterioration of graphite is significant.

As another negative electrode active material of a nonaqueous electrolyte battery, for example, spinel lithium titanate (Li₄Ti₅O₁₂) is known. When lithium titanate is used, precipitation of lithium dendrite can be suppressed. Thus risks such as short circuit, self-discharge, and ignition can be avoided, and a battery excellent in large current output performance and life performance can be produced.

Examples of the positive electrode active material of a nonaqueous electrolyte battery include lithium nickel cobalt manganese oxide excellent in large capacity performance. A conventional battery using lithium nickel cobalt manganese oxide for a positive electrode and lithium titanate for a negative electrode has excellent characteristics such as rapid charge-and-discharge performance, long-term life performance, and low-temperature performance, as compared with batteries using a graphite-based negative electrode. However, there is room for improvement in the active material of the positive electrode. In particular, there is a problem with life performance.

In a battery using secondary particles of lithium nickel cobalt manganese oxide as positive electrode active material, when the positive electrode is pressed in order to enhance the electrode density thereof or when the positive electrode active material is repetitively expanded and contracted through charging and discharging, cracking of particles of the active material take place, making the specific surface area increase. Further, while a lithium nickel cobalt manganese oxide of a polycrystalline class, in which fine primary particles having a particulate shape are agglomerated to form secondary particles, is generally used, the polycrystalline class has a large surface roughness and a large specific surface area, as compared to the primary particles. The positive electrode using such an active material has problems in that during charge and discharge using a high potential and storage at a high potential state, an oxidation reaction between the positive electrode and the electrolyte is apt to occur, whereby performance deterioration is significant.

A known measure against the problems is use of a single crystal active material having high breaking strength and small surface roughness, whereby the charge-discharge cycle life and the calendar life are improved. However, when the surface roughness is reduced, the number of contact points between the active material and the electro-conductive agent tends to decrease accordingly. Thus, contact between the active material and the electro-conductive agent is likely to be lost through expansion and contraction of the active material associated with the charge-discharge cycle. Within the electrode, flow of electrical current is difficult at portions where contact between the active material and the electro-conductive agent is lost, on one hand. On the other hand, in portions maintaining contact, the electrical current preferentially flows. As a result, there is a problem in that the positive electrode potential increases locally, making deterioration of the active material progress more readily.

### BRIEF DESCRIPTION OF THE DRAWINGS

FIG. 1 is a plan view schematically showing an example of an electrode according to an embodiment.

FIG. 2 is a sectional view of an example of a battery according to an embodiment, cut in a thickness direction.

FIG. 3 is an enlarged sectional view of section A of FIG. 2.

FIG. 4 is a partially cutaway perspective view of another example of the battery according to the embodiment.

FIG. 5 is an exploded perspective view of a battery pack of an example according to an embodiment.

FIG. 6 is a block diagram showing an electric circuit of the battery pack shown in FIG. 5.

### DETAILED DESCRIPTION

According to one embodiment, provided is an electrode including a current collector and an active material-containing layer on the current collector. The active material-containing layer contains an active material and an electro-conductive agent. The active material includes a lithium nickel cobalt manganese composite oxide. A specific surface area S_{BET} of the active material-containing layer according to a nitrogen gas adsorption method and a pore specific surface area S_{Hg} of the active material-containing layer according to a mercury intrusion method satisfy a relationship of 0.8<S_{BET}/S_{Hg}<2.0. A volume resistivity R_{V} of the active material-containing layer is 10 Ω·cm or less. An interfacial resistance R_{I} of an interface between the current collector and the active material-containing layer is 0.5 Ω·cm² or less. A ratio R_{V}/R_{I} of the volume resistivity R_{V} to the interfacial resistance R_{I} is 3 cm-1 or more and 20 cm-1 or less.

According to another embodiment, provided is a battery including the above electrode and an electrolyte. According to yet another embodiment, provided is a battery pack including the above battery.

In a conventional positive electrode for a lithium secondary battery obtained using a lithium-containing metal composite compound as a positive electrode active material, an active material having a small surface roughness, which is less likely to cause a side reaction, may sometimes be used in order to enhance the life performance of the positive electrode. However, when an active material having a small surface roughness, such as one of a single crystal, is used, not only is the number of contact points with the electro-conductive agent and the current collector small, but also, electrical contact is more apt to be lost due to expansion and contraction of the positive electrode associated with charge and discharge of the battery. In such a positive electrode, electrical current preferentially flows in a portion where the contact between the active material and the electro-conductive agent is favorably maintained, so that the positive electrode potential may locally increase. Accordingly, there is observed a tendency where the positive electrode active material deteriorates at the portions where the positive electrode potential had increased, whereby resistance increase and significant gas generation arise.

Furthermore, when the interfacial resistance between the layer containing an active material and a current collector is large, flow of electric current to the active material within the active material-containing layer becomes difficult, and the deterioration of the battery is accelerated. In general, an active material and a current collector are bound by a binder, and electrical conductivity is ensured via distribution of an electro-conductive agent to the binding section or direct contact with the current collector. When an active material having a small surface roughness such as one of a single crystal is used, like so, the number of contact points with the electro-conductive agent and the current collector is small, and thus the interfacial resistance increases.

On one hand, one measure against the above problems is increasing of the amount of the electro-conductive agent. In particular, addition of carbon black or a carbon nanotube, which have a small particle size making them easily distributed within fine gaps of the interface between the current collector and active material-containing layer, in a large amount is known to be capable of reducing the interfacial resistance. On the other hand, even if the interfacial resistance is eagerly reduced, if the interfacial resistance is significantly low compared to the volume resistivity of the active material-containing layer itself, a resulting state is one where electrical current is apt to flow in the vicinity of the interface, and where electrical current does not flow easily in the other parts of the active material-containing layer. Thus, there arises a problem where a large current easily flows to the active material in the vicinity of the interface, in particular, during high rate cycles, making the positive electrode potential increase locally, whereby deterioration of the active material easily proceeds.

The above problems can be summarized as follows. For lithium nickel cobalt manganese oxide, a positive electrode active material excellent in large capacity performance, a single crystal class is desirably used from the viewpoint of life performance. However, since the surface roughness thereof is small, a problem is likely to occur in the contact with the electro-conductive agent. Furthermore, the contact between the single crystal class active material and the current collector is easily lost, and the interfacial resistance is likely to increase. On the other hand, even if a large amount of an electro-conductive agent such as carbon black or a carbon nanotube is added to reduce the interfacial resistance, there is a problem in that a difference between the resistance of the active material-containing layer and the interfacial resistance is likely to arise, whereby the life performance deteriorates.

Hereinafter, embodiments will be described with reference to the drawings. The same reference signs are applied to common components throughout the embodiments and overlapping explanations are omitted.

Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, an electrode is provided. The electrode includes a current collector and an active material-containing layer on the current collector. The active material-containing layer contains an active material including a lithium nickel cobalt manganese composite oxide and an electro-conductive agent. For the active material-containing layer, a specific surface area S_{BET} determined by a nitrogen gas adsorption method and a pore specific surface area S_{Hg} determined by a mercury intrusion method satisfy a relationship of 0.8<S_{BET}/S_{Hg}<2.0. A volume resistivity R_{V} of the active material-containing layer is 10 Ω·cm or less. An interfacial resistance R_{I} of an interface between the current collector and the active material-containing layer is 0.5 Ω·cm² or less. A ratio R_{V}/R_{I} of the volume resistivity R_{V} to the interfacial resistance R_{I} is 3 cm⁻¹ or more and 20 cm⁻¹ or less.

The electrode according to the embodiment may be a battery electrode. An example of the battery within which the electrode may be included is a secondary battery such as a lithium secondary battery. The secondary battery includes nonaqueous electrolyte secondary batteries containing nonaqueous electrolyte(s). The electrode may be a positive electrode for a battery, for example.

The electrode satisfying the above configuration is an electrode using a single crystal type lithium nickel cobalt manganese composite oxide (NCM). As compared with a positive electrode using a secondary particle type NCM having different surface structure and surface area depending on the manner of agglomeration of primary particles, the electrode has less micropores and also has a uniform surface state. Therefore, the specific surface areas as measured by a nitrogen gas adsorption method and a mercury intrusion method are of values of the same degree. In addition, when comparison in pore capacity obtained by the mercury intrusion method is made between the single crystal type and the secondary particle type, the single crystal type having fewer pores has a smaller value. A single crystal type NCM in which a value defined by a ratio S_{BET}/S_{Hg} of a specific surface area S_{BET} obtained by the nitrogen gas adsorption method (based on a BET (Brunauer, Emmett, Teller) method as will be described later) to a pore specific surface area S_{Hg} obtained by the mercury intrusion method is closer to 1.0 can be more improved in life performance. The single crystal type NCM has fewer micropores and a uniform surface state as compared with the secondary particle-class NCM, and thus the S_{BET}/S_{Hg} tends to be a value close to 1.0. By having the single crystal NCM with specific surface area values not varying depending on the measurement method as the active material and controlling the electrode density, the contact area with the electrolytic solution can be controlled, allowing improvement of battery performance.

When the ratio S_{BET}/S_{Hg} of the specific surface area S_{BET} as measured by the N₂ gas adsorption method to the pore specific surface area S_{Hg} as measured by the mercury intrusion method for the active material-containing layer is within a range of 0.8<S_{BET}/S_{Hg}<2.0, an effective area contributing to an electrode reaction can be accurately controlled, and thus, the electric resistance can be reduced and the gas generation can be suppressed. Namely, by satisfying the above relationship, the specific surface area of the active material can be made small, whereby an oxide reaction between the electrode and electrolyte, which is a significant problem in charge-discharge cycles and storage using particularly high electrical potentials, can be suppressed, and thus, an electrode providing favorable life performance can be obtained.

The specific surface area S_{BET} as measured by the nitrogen gas adsorption method for the active material-containing layer mainly reflects a specific surface area of micropores and mesopores having a pore diameter on the scale of about 0.1 nm to 100 nm among pores in the electrode. In contrast, the pore specific surface area S_{Hg} as measured by the mercury intrusion method mainly reflects a specific surface area of mesopores and macropores having a pore diameter on the scale of about 1 nm to 1 mm among pores in the active material-containing layer. That is, the ratio S_{BET}/S_{Hg} between the two is an index representing a proportion of the micropores and macropores in the electrode. When 0.8>S_{BET}/S_{Hg} Or S_{BET}/S_{Hg}>2.0, many of either the micropores or the macropores are present. In that case, the effective area contributing to side reactions between the active material and the electrolytic solution (liquid electrolyte) is difficult to control, and on top of that, electric resistance increases since the reaction area increases. More preferably, the ratio of the specific surface area S_{BET} to the pore specific surface area S_{Hg} desirably satisfies a relationship of 0.85<S_{BET}/S_{Hg}<1.15. In an electrode in which a difference in specific surface area is closer than 158, the above-mentioned electrode reaction area is better controlled, and the effect of reducing the electric resistance is more remarkably obtained.

The specific surface area S_{BET} of the active material-containing layer as measured by the nitrogen gas adsorption method is preferably set within a range of 1.0 m²/g≤S_{BET}≤5.0 m²/g. When the specific surface area S_{BET} is 1.0 m²/g or more, permeation of the electrolytic solution is promoted, and the output performance and the life performance are improved. When the specific surface area S_{BET} is 5.0 m²/g or less, the contact between the active material particles and the contact between the active material and the electro-conductive agent are increased, whereby the electric resistance is further reduced, and the large current output performance is improved. In addition, the mechanical stability of the electrode is increased. With an electrode in which the specific surface area S_{BET} according to the nitrogen gas adsorption method satisfies the above range, the contact between the active material and the electro-conductive agent can be improved, so that the electric resistance can be reduced, and a battery excellent in input/output performance can be produced. More desirably, the active material-containing layer further has the preferred density of more than 3.0 g/cm³ and less than 3.6 g/cm³ described above, in addition thereto. More preferably, the specific surface area S_{BET} of the positive electrode active material-containing layer according to the nitrogen gas adsorption method is desirably within a range of 2.5 m²/g≤S_{BET}≤3.0 m²/g. In the more preferable range, the active material, electro-conductive agent, and binder are well dispersed, and appropriate control of the electrode density can be performed easily, therefore, a battery with lower resistance and high input/output performance can be produced.

The electrode includes a current collector and an active material-containing layer (electrode mixture layer). The current collector may have, for example, a foil shape, a band shape, or a plate shape. The active material-containing layer may be provided on a surface of at least one principal surface of the current collector. That is, the current collector can support the active material-containing layer on one surface or both of obverse and reverse surfaces. The current collector may include a portion that does not support the active material-containing layer on the surfaces thereof. This portion can serve as a current-collecting tab. Alternatively, the electrode may include a current-collecting tab separate from the current collector.

The active material-containing layer contains an active material and an electro-conductive agent. The active material-containing layer may contain a binder, in addition to the active material and electro-conductive agent. The binder may be blended to bind the dispersed active materials and to bind the active material and the current collector.

In the electrode, the volume resistivity R_{V} of the active material-containing layer is 10 Ω·cm or less, and the interfacial resistance R_{I} of the interface between the current collector and the active material-containing layer is 0.5 Ω·cm² or less. In the electrode, even while using an active material of single crystal class having a small surface roughness, the contact between the active material and the electro-conductive agent is favorable, and loss of contact associated with expansion and contraction during charge-discharge cycles hardly occurs. Thus, an electrode providing good life performance can be obtained.

In the electrode, the ratio R_{V}/R_{I} of the volume resistivity R_{V} of the active material-containing layer to the interfacial resistance R_{I} between the current collector and the active material-containing layer satisfies the relationship of 3 cm⁻¹<R_{V}/R_{I}≤20 cm⁻¹. In the electrode satisfying the relationship, the balance between the volume resistivity R_{V} and the interfacial resistance R_{I} is favorable, and a non-uniform current distribution, in which the current more easily flows to the active material in the vicinity of the interface of current collector/active material-containing layer than the active material in other parts, is less likely to occur during charging and discharging of the battery. Thus, by satisfying the above relationship, local deterioration of the active material in the vicinity of the interface can be suppressed, so that an electrode exhibiting good cycle performance can be obtained.

The thickness of the active material-containing layer is desirably 10 μm or more and 60 μm or less. An electrode containing an active material-containing layer having a thickness of 10 μm or more can attain high capacity. In the active material-containing layer having a thickness of 60 μm or less, a distribution of the electro-conductive agent that can fulfill the above-mentioned good balance between the volume resistivity R_{V} and the interfacial resistance R_{I} is easily achieved.

The active material-containing layer may contain, as an active material, a lithium nickel cobalt manganese composite oxide represented by the formula LiₐNi_{(1-b-c-d)}CO_{b}Mn_{c}M_{d}O₂. The subscripts in the formula are within ranges of 1≤a≤1.2, 0≤b≤0.4, 0≤c≤0.4, and 0≤d≤0.1, respectively. M includes at least one selected from the group consisting of Fe, Cu, Ti, Mg, Al, W, Y, B, Mo, Nb, Zn, Sn, Zr, Ga, and V.

The active material may have an average primary particle diameter of 2 μm or more and 7 μm or less. By having the primary particle diameter of the active material particles be 2 μm or more and 7 μm or less in the active material-containing layer, the life performance of the battery can be improved. With a primary particle diameter 2 μm or more, the specific surface area of the electrode is small, and influence of side reactions between the electrode and the electrolyte on the life performance can be diminished. In addition, with an average primary particle diameter of 7 μm or less, in-solid diffusion of lithium ions within the particles becomes uniform, whereby structural deterioration is suppressed even further, thereby improving life performance. More preferably, the primary particle diameter is desirably 3 μm or more and 4.5 μm or less. In a more preferable range, the life performance can be further improved by preventing aggregation and isolation of the primary particles.

In addition, the specific surface area of the active material is preferably 0.5 m²/g or more and 2.0 m²/g or less. The specific surface area of the active material as used herein refers to a specific surface area as measured by the nitrogen gas adsorption method for the active material particles in a solitary state without forming a layer. When the specific surface area of the active material is 0.5 m²/g or more, the contact area between the active material and the electro-conductive agent increases, and the output performance can be improved. When the specific surface area of the active material is 2.0 m²/g or less, the contact area between the active material and the electrolytic solution is kept to a moderate size, and the side reactions are suppressed, so that the electric resistance is less likely to increase. Therefore, by having the specific surface area of the active material particles be 0.5 m²/g or more and 2.0 m²/g or less, the contact area between the active material and the electrolytic solution can be made appropriate, and an electrode and a battery having low resistance and excellent life performance can be produced. More preferably, the specific surface area of the active material is desirably 0.5 m²/g or more and 1.0 m²/g or less. In a more preferable range, the contact area between the active material and the electrolytic solution can be easily controlled, and an electrode having low resistance and excellent life performance can be easily obtained.

### Material

Next, materials that can be used in the active material-containing layer and current collector included in the electrode according to the first embodiment will be described.

### <Active Material-Containing Layer>

As mentioned above, the active material-containing layer may contain a binder, in addition to the active material and electro-conductive agent. The blending proportions of the active material, electro-conductive agent and binder in the active material-containing layer are preferably within the ranges of 80% by mass to 95% by mass of the active material, 0.5% by mass to 18% by mass of the electro-conductive agent, and 0.5% by mass to 17% by mass of the binder.

### <Active Material>

The active material-containing layer contains a lithium nickel cobalt manganese composite oxide as an active material. As the lithium nickel cobalt manganese composite oxide, the above-mentioned LiₐNi_{(1-b-c-d)}CO_{b}Mn_{c}M_{d}O₂ is preferably contained. Furthermore, an active material, which includes this lithium nickel cobalt manganese composite oxide and that has an average primary particle diameter within a range of 2 μm or more and 7 μm or less, is more preferably contained. The active material-containing layer may contain a lithium nickel cobalt manganese composite oxide as the first active material and, further, a second active material other than that. As a matter of course, the first active material may be used alone, or alternatively, one or more second active material may be contained without containing the first active material.

As the second active material, various oxides, for example, lithium cobalt composite oxides (for example, LiCoO₂), manganese dioxide, lithium manganese composite oxides (for example, LiMn₂O₄ and LiMnO₂), lithium nickel composite oxides (for example, LiNiO₂), lithium nickel cobalt composite oxides (for example, LiNi_{0.8}Co_{0.2}O₂), lithium-containing iron oxides, vanadium oxides containing lithium, chalcogen compounds such as titanium disulfide and molybdenum disulfide, and the like may be included. The electrode may contain one of the above compounds as the second active material, or include two or more of the above compounds as the second active material.

A proportion of a mass of the first active material among an entire mass of active materials contained in the active material-containing layer is preferably 75 mass % or more and 100 mass % or less, and more preferably 80 mass % or more and 100 mass % or less.

The active material can have, for example, a particle shape. Namely, the active material-containing layer can contain particles of the active material. The active material particles may be primary particles or a mixture of primary particles and secondary particles.

Preferably among the active material particles, a proportion of the primary particles is large and a proportion of the secondary particles is small. The electrical conductivity inside the secondary particles (inside a hollow structure) is poor, and so, by eliminating the presence of the primary particles contained therein, further reduction of the electric resistance possible.

From the above, while the aggregation of secondary particles of the active material is desirably resolved, the primary particles of the active material are desirably not further ground, so as to maintain a particle size of 2 μm or more. By refraining from grinding the primary particles of the active material, an active material having a good crystal structure is obtained, and good life performance can be maintained. In addition, by having the average particle diameter of the active material be 2 μm or more, the specific surface area of the electrode can be reduced, and the influence of side reactions between the electrode and the electrolyte on the life performance can be reduced. On the other hand, by having the average particle diameter be 7 μm or less, in-solid diffusion of lithium ions within the particles can be made uniform, thereby further improving the life performance.

### <Electro-Conductive Agent>

The electro-conductive agent preferably includes a carbon material. Examples of the carbon material include carbon black such as acetylene black, Ketjen black, and furnace black, graphite, and carbon nanotubes. The active material-containing layer may contain a single species of electro-conductive agent or contain two or more species of electro-conductive agents.

For example, an electro-conductive agent that can be distributed so as to fill gaps between active materials, such as carbon black and carbon nanotubes, is desirably contained simultaneously with an electro-conductive agent that can serve as a wide electrically conductive path connecting a plurality of active material particles by having a relative large particle diameter, such as flake graphite. The former one is distributed so as to fill gaps between active materials when, for example, a press treatment is carried out at the time of producing an electrode, and acts as an electrically conductive path between the active materials. Thus, since the electro-conductive agent can be distributed over the entire electrode, if the content of the former electro-conductive agent is increased, an effect of reducing both the volume resistance R_{V} and the interfacial resistance R_{I} is exhibited. The latter has difficulty in entering fine gaps such as the current collector/active material-containing layer interface, and tends to be distributed within the bulk body of the active material-containing layer. For example, by increasing the content of the flake graphite, the volume resistance R_{V} can be preferentially reduced. As a result, the electrical conductive path breakage of the single crystal active material and the local deterioration of the active material due to deviation between the volume resistance R_{V} and the interfacial resistance R_{I} can be suppressed. Thus, the content of the flake graphite in the active material-containing layer is preferably 3 mass or more relative to the mass of the active material-containing layer.

The graphite includes, other than flake graphite high in orientation, spherical graphite lowered in orientation. Natural graphite is flake graphite. The spherical graphite is graphite obtained by spheroidizing treatment.

### <Binder>

As the binder, a material containing a fluorine atom within its molecule is preferable for being excellent in oxidation resistance and improving life performance. Examples of such a binder include polytetrafluoroethylene (PTFE), polyvinylidene fluoride (PVdF), and fluororubbers. Other than that, as the binder, for example, styrene butadiene rubber, an acrylic resin and a copolymer thereof, polyacrylic acid, polyacrylonitrile, and the like may be used. In addition, a binder where a modified group is introduced into the above binder may be used, as well. The active material-containing layer may contain a single species of the above binders, or may contain two or more species of the above binders.

### <Current Collector>

As the current collector, for example, a metal foil or an alloy foil may be used. Examples of the metal foil include an aluminum foil, a stainless steel foil, and a nickel foil. Examples of the alloy foil include an aluminum alloy, a copper alloy, and a nickel alloy.

Next, a specific example of the electrode according to the first embodiment will be described with reference to the drawings.

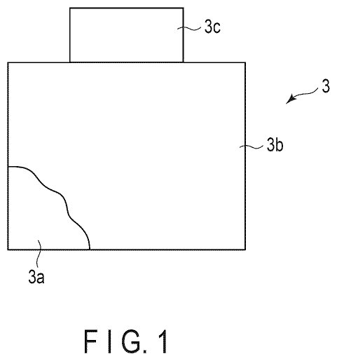

FIG. 1 is a partially cutaway plan view schematically showing an example of the electrode according to the embodiment. Here, an example of a positive electrode is illustrated as an example of the electrode.

A positive electrode 3 shown in FIG. 1 includes a positive electrode current collector 3a and a positive electrode active material-containing layer 3b provided on a surface of the positive electrode current collector 3a. The positive electrode active material-containing layer 3b is supported on the principal surface of the positive electrode current collector 3a.

The positive electrode current collector 3a includes a portion on which the positive electrode active material-containing layer 3b is not provided. This portion serves as, for example, a positive electrode current-collecting tab 3c. In the illustrated example, the positive electrode current-collecting tab 3c is a narrow portion that is narrower than the positive electrode active material-containing layer 3b. The positive electrode current-collecting tab 3c may be narrower than the positive electrode active material-containing layer 3b in such a manner, or may be equal in width to the positive electrode active material-containing layer 3b. Instead of the positive electrode current-collecting tab 3c which is a part of the positive electrode current collector 3a, a separate electrically conductive member may be electrically connected to the positive electrode 3 and may be used as an electrode current-collecting tab (positive electrode current-collecting tab).

### Production Method

The electrode according to a first embodiment can be produced, for example, by the following method.

First, a main active material (first active material) is prepared. As the first active material, at least one species of lithium nickel cobalt manganese composite oxide is used. For example, a preferred active material including the above-described lithium nickel cobalt manganese composite oxide and having an average primary particle diameter of 2 μm or more and 7 μm or less can be obtained as follows. A precursor using nickel, cobalt, and manganese sources is fired. Here, when the firing temperature is increased, the firing time is increased, or the amount of a precursor serving as a lithium source including lithium carbonate is increased, particle growth is promoted rather than nucleation. Therefore, a lithium nickel cobalt manganese composite oxide with particle growth promoted by a method of choice, having a primary particle diameter of 2 μm or more and a chemical composition optimized so that a nickel content ratio is a predetermined value or more, can be synthesized.

The lithium nickel cobalt manganese composite oxide prepared as the first active material, an optional second active material, an electro-conductive agent, and an optional binder are added to an appropriate dispersion medium to obtain a mixture. Examples of the dispersion medium include NMP (N-methyl-2-pyrrolidone). The addition amounts of individual materials preferably fall within ranges satisfying the blend ratio described above.

Subsequently, the obtained mixture is put into a stirrer. In the stirrer, the mixture is stirred to obtain a slurry. In the stirring procedure, the grinding of the active material and electro-conductive agent particles can be promoted by increasing the rotation speed of the stirrer, and thus the value of the specific surface area S_{BET} of the produced electrode can be improved. The obtained slurry may be further subjected to processing by a pulverizer, so that the active material and the electro-conductive agent of the slurry can be more finely dispersed. In addition, an optional dispersant may be used in order to improve the dispersibility of the electro-conductive agent.

The slurry thus obtained is applied onto both or either one of the obverse and reverse surfaces of the current collector. At this time, a part where no slurry is applied on any surface of the current collector may be kept remaining. Subsequently, the coating film is dried. Regarding the drying rate, appropriate conditions vary depending on the species of binder. For example, in a case where a binder having a modified group is used, the modified group can trap the electro-conductive agent. Accordingly, even if binders have the same molecular weight, in a case of a binder having a modified group, dislocation of the electro-conductive agent away from the interface between the coating film and the current collector occurs more readily as compared with the binder having no modified group, due to migration within the coating film. Thus, when a binder having a modified group is used, the coating film is preferably dried with the drying rate lowered.

Next, the dried coating film is pressed. At this time, the electrode density can be improved by increasing the press load. For example, the degree of penetration of carbon black between the active material particles can be controlled. In addition, as the press load is increased, the diameter of pores inside the electrode and the pore specific surface area Sig that can be measured by the mercury intrusion method can be reduced and adjusted to values within the above ranges providing excellent performance. In this manner, an electrode can be produced.

The pore distribution within the active material-containing layer can be controlled to fall within the range described above, for example, by selecting the species and blending ratios of active material, electro-conductive agent and binder, and controlling parameters such as the particle diameters of particles of the active material and the electro-conductive agent, the stirring (dispersion) condition of the mixture, and the pressing condition. In addition, in the stirring procedure, a slurry sufficiently maintaining the electrical conductive network of the electro-conductive agent can be obtained by decreasing the rotation of the stirrer. Conversely, a slurry having the active material well dispersed therein can be obtained by increasing the rotation of the stirrer. In the electrode produced using the slurry obtained by decreasing or increasing stirring as described above, the value of the pore specific surface area S_{Hg} can be improved. In addition, the electrode density can be improved by increasing the press load, as described above, and an electrode having satisfactory electrical contact and excellent capacitance tends to be more readily produced with a higher electrode density. Reversely, by decreasing the press load to thereby increase the diameters of pores inside the electrode and the pore specific surface area S_{Hg} that can be measured by the mercury intrusion method, an excellent electrode having low input resistance can be produced.

Specific examples of electrode production will be described in Examples given later.

### Measurement of Electrode

Various measurement methods for the electrode will be described. Specifically, a method of measuring the composition of the active material, a method of measuring the average primary particle diameter of the active material particles, a method of measuring the pore specific surface area S_{BET} by the nitrogen gas adsorption method, a method of measuring the pore specific surface area S_{Hg} by the mercury intrusion method, a method of measuring the volume resistivity R_{V} of the active material-containing layer, a method of measuring the interfacial resistance R_{I} of the interface between the current collector and active material-containing layer, and a method of measuring the content of electro-conductive agent in the active material-containing layer will be described.

When analyzing an electrode incorporated in a battery, the electrode is taken out by the following procedures.

First, a battery to be measured is prepared. The battery to be measured should have a discharge capacity of 100% or more of the nominal capacity. That is, a deteriorated battery should not be measured. Next, the prepared battery is put into a discharged state. For example, in the case of a nonaqueous electrolyte battery including a lithium nickel cobalt manganese composite oxide as positive electrode active material and lithium titanate as negative electrode active material, the battery is discharged at a current value equivalent to a reference current value from any state of charge to a battery voltage of 1.5 V.

The discharged battery is then transferred into an argon-filled glove box in which the internal atmosphere has a dew point of −70° C. The battery is cut open in such a glove box. An electrode group is taken out from the cut-opened battery. During the sequence of dismantling operations, precaution should be taken so as to keep electrical insulation between the positive electrode and the negative electrode.

Next, the electrode group is dismantled and disassembled into a positive electrode, a negative electrode, and a separator. For example, the positive electrode is selected as the electrode to be measured. The electrode thus obtained is washed with ethyl methyl carbonate as a solvent. In this washing, the member obtained by disassembly is completely immersed in the ethyl methyl carbonate solvent, and left in that state for 60 minutes.

After washing, the electrode is subjected to vacuum drying. The vacuum drying is carried out by reducing the pressure from atmospheric pressure to −97 kpa or more in a 25° C. environment and retaining that state for 10 minutes. The electrode thus taken out through the disassembly, washing and vacuum drying is subjected to the following measurements.

### <Measurement of Active Material Composition>

The composition of the electrode active material can be known by measuring a surface of the electrode by X-ray fluorescence (XRF).

### <Measurement of Average Primary Particle Diameter of Active Material Particles>

The average primary particle diameter of active material particles can be measured by a laser diffraction scattering method described in the following.

After preparing the electrode to be measured, the active material-containing layer is taken off from the electrode using, for example, a spatula to obtain a powdery electrode mixture specimen including the active material. Next, the powdery sample is fired so as to remove the binder and electro-conductive agent, isolating the active material particles. The obtained sample of active material particles is charged into a measurement cell filled with N-methylpyrrolidone (NMP) up to the concentration at which measurement becomes possible. Note, that the capacity of the measurement cell and the measurable concentration vary depending on the particle size distribution measuring device.

The measurement cell containing NMP and the active material specimen dissolved therein is irradiated with ultrasonic waves at an output of 40 W for 5 minutes. Such ultrasonic irradiation can resolve the agglomeration of the active material particles.

The measurement cell that has been subjected to the ultrasonic treatment is inserted into a particle size distribution measuring device using a laser diffraction scattering method, and the particle diameter distribution is measured. An example of the particle size distribution measuring device is Microtrac 3100. The average primary particle diameter of the active material can be determined from the particle diameter distribution of the active material particles. The particle diameter (D₅₀), at which the cumulative frequency from the small particle diameter side is 50% in the measured particle diameter distribution, corresponds to the average primary particle diameter of the active material.

### <Measurement of Pore Specific Surface Area by Nitrogen Gas Adsorption Method>

The pore specific surface area S_{BET} by the nitrogen (N₂) gas adsorption method for the active material-containing layer corresponds to the BET specific surface area of the electrode. The BET specific surface area is a specific surface area determined by the BET method, and is calculated by the nitrogen gas adsorption method. Analysis is performed, for example, by the following method.

From the electrode, a plurality of strip-shaped pieces as measurement samples each having a planar shape having dimensions of 5 mm×20 mm are cut out. The weight of each of the cut-out measurement samples is measured. Next, 24 measurement samples are loaded into a cell of a measuring device. These measurement samples are placed in the measurement cell for nitrogen adsorption/desorption measurement, and dried at a temperature of 120° C. or higher under a nitrogen gas flow. Thereafter, the specific surface area is measured by a BET one-point method or a BET multi-point method. An example of the measuring device that performs nitrogen gas adsorption measurement is Quantasorb manufactured by QUANTACHROME.

### <Measurement of Pore Specific Surface Area by Mercury Intrusion Method>

A method for measuring the pore specific surface area S_{Hg} of the active material-containing layer by the mercury intrusion method will be described below.

From the electrode, a plurality of strip-shaped pieces as measurement samples each having a planar shape having dimensions of 12 mm×25 mm are cut out. The weight of each of the cut-out measurement samples is measured. Next, 16 measurement samples are folded and loaded into a cell of a measuring device. These measurement samples are measured under conditions of an initial pressure of 20 kPa (corresponding to a pore diameter of about 60 μm) and a terminal pressure of 400 MPa (corresponding to a pore diameter of about 3 nm).

Next, from another measurement sample cut out from the same electrode, the active material-containing layer is taken off using, for example, a spatula to obtain a current collector piece. The weight of the current collector piece is measured. The weight of the active material-containing layer that had been contained in the measurement sample is determined by subtracting the weight of the current collector piece from the weight of the measurement sample measured earlier. In addition, the pore distribution excluding the current collector weight is recalculated for a specific range (0.003 μm to 2 μm).

From the pore distribution obtained as described above and the weight of the active material-containing layer included in the measurement sample, the pore specific surface area (unit: m²/g) of the active material-containing layer can be determined.

The pore specific surface area (pore specific surface area S_{Hg}) is calculated assuming that the shape of the pores is cylindrical.

The analysis principle of mercury porosimetry is based on the following Washburn's equation (1).

$$D = - 4 γcosθ / P \qquad ( 1 )$$

Here, D is a pore diameter, γ is a surface tension of mercury (480 dyne·cm⁻¹), θ is the angle of contact between mercury and the pore wall surface (140°), and P is applied pressure. Since γ and θ are constants, the relationship between the applied pressure P and the pore diameter D is obtained from Washburn's equation (1), and by measuring a mercury intrusion volume at that time, the pore diameter and its volume distribution can be derived.

An example of a measuring apparatus for performing the pore distribution measurement is the pore distribution measurement apparatus Autopore 9520 manufactured by Micromeritics Instrument Corp.

### <Measurement of Volume Resistivity of Active Material-Containing Layer and Interfacial Resistance Between Current Collector and Active Material-Containing Layer>

A plurality of square measurement samples having a planar shape of 50 mm×50 mm in dimension are cut out from the electrode. After the thickness of the active material-containing layer, the thickness of the current collector, and the volume resistivity of the current collector are separately measured, the sample is examined so as to confirm the sample is sufficiently dry, and then the electrode resistance is measured.

Herein, the volume resistivity of the active material-containing layer and the interfacial resistance between the current collector and the active material-containing layer are calculated by modeling the electrode sheet as being a virtual electrode sheet including two layers+one interface layer. A constant current is supplied to a surface of the electrode sheet, and a potential distribution on the surface is obtained by measuring multiple points. Next, the resistance of each layer is used as a variable, and the calculated potential that matches the measured potential is obtained by iterative calculation (curve regression). When the measured potential and the calculated potential match, each of the volume resistivity of the active material-containing layer and the interfacial resistance between the current collector and the active material-containing layer can be calculated. For the calculation, information on the thickness of the active material-containing layer, the thickness of the current collector, and the volume resistivity of the current collector need to be separately prepared. For example, the information is obtained by measurement in advance using some of the plural samples cut out. However, for the volume resistivity of the current collector, measurement can be omitted as long as the constituent material of the current collector can be determined. For example, if the current collector is made of Al or Cu, a general physical property value thereof can be used.

As an example of the measurement apparatus for measuring the volume resistivity of the active material-containing layer and the interfacial resistance between the current collector and the active material-containing layer, for example, an electrode resistance measurement system RM2610 manufactured by HIOKI E.E. CORPORATION can be mentioned. Each of the measurement samples cut out is gently placed on the electrode resistance measurement apparatus without bending, and the electrode probe is pressed onto the sample to measure the volume resistance of the active material-containing layer. The measurement is performed in the mode of potential measurement+calculation; the resistance range is set to the Auto range; and the number of iterations of the calculation is set to 30.

### <Measurement of Content of Electro-Conductive Agent in Active Material-Containing Layer>

For measuring the content of the electro-conductive agent in the active material-containing layer, a constituent material mapping image detection using Raman spectroscopy may be mentioned as a method. The measurement procedure will be described below.

The electrode taken out by the above-described method is fixed so that the cross-section of the active material-containing layer faces the direction from which Raman measurement laser is emitted. Specifically, as a fixing method, a sample can be prepared as follows. A sample is put in a container so that the cross-section thereof faces upward, and the sample is fixed to the bottom surface of the container with a metal fitting. A curable resin is poured into the container and allowed to stand until the resin is completely cured to fix the electrode in a state with the cross-section thereof facing in a direction of choice. Thereafter, a new cross-section is exposed by mechanically cutting the sample along a plane parallel to the bottom surface to prepare a measurement sample whose cross-section can be observed. At this time, graphitization may proceed depending on the carbon material used. Therefore, the energy during the cutting needs to be reduced to the extent that the measurement is not affected.

The sample is fixed to a sample stage and loaded in a Raman spectrometer. On the sample loaded, surface Raman spectrometry is performed in a visual field of 50 μm×50 μm to obtain a Raman chart. When obtaining the Raman chart, measurement is performed at 10,000 points, which are obtained by dividing the 50 μm×50 μm visual field into 100 points in the longitudinal direction and 100 points in the lateral direction. As the measurement apparatus for the Raman spectrometry, for example, a confocal microscopic analyzer α300 manufactured by WITec can be mentioned. The measurement conditions are, for example, as follows. However, in a case where the thermal influence on the sample is large, reduction of exposure time and increase of accumulation number, or reduction of laser power is necessary. In opposite, when an unclear spectrum is obtained, the exposure time is increased or the accumulation number is increased:
Exposure time: 10 s or 20 s
Accumulation number: 1
Lens magnification: 50×
Measurement range: 50 μm×50 μm
Laser power: 5%.

### (Creation of Constituent Material Mapping Image)

Next, using the Raman charts of the 10,000 points, spectra are extracted from 10 nondiscriminatory points in each high concentration region and an average spectrum is obtained. The average spectrum is subjected to multivariate analysis and significant spectral components are separated. Based on the peak position, intensity, and intensity ratio for the spectrum of each of the separated spectral components, the crystallinity of the active material and the electro-conductive agent are determined. The proportion of presence of each constituent material is mapped using the obtained spectrum for each of the constituent materials and the Raman chart for the 10,000 points.

Herein, the ratio of the integral intensity of D band appearing at 1350+10 cm⁻¹ and the integral intensity of G band appearing at 1590+10 cm⁻¹ in the Raman chart varies depending on the species of carbon material. For example, in the case of carbon black, the integral intensity of D band due to the disturbance of the structure is large, and the ratio of the integral intensity I_{D} of D band to the integral intensity I_{G} of G band satisfies the relationship of 0.5<I_{D}/I_{G}<2.0. For high crystallinity carbon such as flake graphite, since the integral intensity of G band due to the stacking structure is large, the ratio of I_{D} to I_{G} satisfies the relationship of 0<I_{D}/I_{G}<0.5. A carbon nanotube (CNT) has a structure in which one or more graphene layers are wound in a tubular shape, and the I_{D}/I_{G} ratio varies depending on the number of layers and the production method. Although these examples have D band and G band in close proximity, even when two or more species of such carbon materials are contained as the electro-conductive agent, the presences of various electro-conductive agents at a point can be distinguished by calculating the degree of overlap by fitting based on the spectra of individual single substances. The proportion of presence of each constituent material can be expressed by shades of different colors for each constituent material, for example.

From the above, the proportion of presence of the active material and the electro-conductive agent in the active material-containing layer can be found from the obtained mapping image. The contents of individual members in the electrode, including the content of the electro-conductive agent, can be obtained by multiplying this value by the density (unit: g/cm³) for each of various materials such as the active material and the flake graphite.

The electrode according to the first embodiment includes a current collector and an active material-containing layer that contains lithium nickel cobalt manganese composite oxide as an active material. In the active material-containing layer, a specific surface area S_{BET} according to a nitrogen gas adsorption method and a pore specific surface area Sug according to a mercury intrusion method satisfy a relationship of 0.8<S_{BET}/S_{Hg}<2.0. A volume resistivity R_{V} of the active material-containing layer is 10 Ω·cm or less, and an interfacial resistance R_{I} at an interface between the current collector and the active material-containing layer is 0.5 Ω·cm² or less. A ratio R_{V}/R_{I} of the volume resistivity R_{V} to the interfacial resistance R_{I} is 3 cm⁻¹ or more and 20 cm⁻¹ or less. The electrode can realize a battery excellent in life performance, with excellent capacity retention ratio and suppressed resistance increase.

### Second Embodiment

According to a second embodiment, a battery is provided. The battery includes the electrode according to the first embodiment and an electrolyte. As described above, the electrode according to the first embodiment can realize a battery having excellent life performance. Therefore, the battery according to the second embodiment can have excellent life performance.

Such a battery may include a positive electrode and a negative electrode. The battery may include the electrode according to the first embodiment as the positive electrode.

The battery may further include a separator provided between the positive electrode and the negative electrode. The positive electrode, the negative electrode, and the separator may configure an electrode group. The electrolyte may be held in the electrode group.

The battery may further include a container member that houses the electrode group and the electrolyte.

The battery may further include a positive electrode terminal electrically connected to the positive electrode and a negative electrode terminal electrically connected to the negative electrode. Each electrode terminal may be connected to, for example, a current-collecting tab of the corresponding electrode. At least a part of the positive electrode terminal and at least a part of the negative electrode terminal may extend outside the container member.

The battery may be, for example, a lithium ion secondary battery. The battery also includes, for example, a nonaqueous electrolyte battery containing a nonaqueous electrolyte as the electrolyte.

Hereinafter, the positive electrode, negative electrode, electrolyte, separator, container member, positive electrode terminal, and negative electrode terminal will be described in detail.

### (1) Positive Electrode

The positive electrode includes a positive electrode current collector and positive electrode active material-containing layer(s) (positive electrode mixture layer(s)) supported on one surface or both the obverse and reverse surfaces of the positive electrode current collector and containing a positive electrode active material, an electro-conductive agent, and a binder.

The positive electrode may be the electrode according to the first embodiment. In an aspect as the positive electrode, the positive electrode current collector, the positive electrode active material, and the positive electrode active material-containing layer of the positive electrode correspond respectively to the current collector, the active material, and the active material-containing layer of the electrode according to the first embodiment. Since the electrode according to the first embodiment has been described in detail above, the description of the positive electrode here is omitted.

### (2) Negative Electrode

The negative electrode includes a negative electrode current collector and a negative electrode active material-containing layer(s) (negative electrode mixture layer(s)) supported on one surface or both the obverse and reverse surfaces of the negative electrode current collector. The negative electrode active material-containing layer contains a negative electrode active material. The negative electrode active material-containing layer can further contain an electro-conductive agent and a binder, in addition to the negative electrode active material. The electro-conductive agent may be blended to improve current collection performance and to suppress the contact resistance between the negative electrode active material and the negative electrode current collector. The binder may be blended to bind the dispersed negative electrode active materials and to bind the negative electrode active material and the negative electrode current collector.

### Material

Hereinafter, materials that can be used in the negative electrode active material-containing layer and the negative electrode current collector will be described.

### <Negative Electrode Active Material-Containing Layer>

The blending proportions of the negative electrode active material, electro-conductive agent and binder in the negative electrode active material-containing layer are preferably within the ranges of 70% by mass to 96% by mass of the negative electrode active material, 2% by mass to 28% by mass of the electro-conductive agent, and 2% by mass to 28% by mass of the binder. With the amount of the electro-conductive agent being 2% by mass or more, the current collecting performance of the negative electrode active material-containing layer can be improved, and therefore, excellent large current performance and low temperature performance can be expected. With the amount of the binder being 2% by mass or more, binding between the negative electrode active material-containing layer and the current collector will be sufficient, and therefore, excellent cycle performance can be expected.

On the other hand, from the perspective of achieving high capacity, 28% by mass or less of each of the electro-conductive agent and binder are preferable.

### <Negative Electrode Active Material>

The negative electrode preferably contains a negative electrode active material capable of having lithium ions inserted and extracted at a potential of 0.4 V (vs. Li/Li⁺) or more. In the battery according to the second embodiment including such a negative electrode, precipitation of lithium due to charge and discharge can be suppressed. Therefore, such a battery is more excellent in rapid charge-discharge performance.

Examples of the negative electrode active material capable of having lithium ions inserted and extracted at a potential of 0.4 V (vs. Li/Li⁺) or more include lithium titanate having a spinel crystal structure represented by Li₄₊ₓTi₅O₁₂ (x varies within a range of −1≤x≤3 according to charge-discharge reaction), Li₂₊ₓTi₃O₇ having a ramsdellite crystal structure (x varies within a range of −1≤x≤3 according to charge-discharge reaction), and a metal composite oxide containing Ti and at least one selected from the group consisting of P, V, Sn, Cu, Ni, and Fe. Examples of the metal composite oxide containing Ti and at least one selected from the group consisting of P, V, Sn, Cu, Ni, and Fe include TiO₂—P₂O₅, TiO₂-V₂O₅, TiO₂-P₂O₅-SnO₂, and TiO₂—P₂O₅-MeO (Me is at least one element selected from the group consisting of Cu, Ni, and Fe). These metal composite oxides are transformed into lithium titanium composite oxides upon insertion of lithium through charging. Of the lithium titanium composite oxides, a spinel lithium titanate is excellent in cycle performance and preferable.

The negative electrode may contain another active material, and examples thereof include carbonaceous materials and metal compounds.

Examples of the carbonaceous material include natural graphite, artificial graphite, coke, vapor-grown carbon fibers, mesophase pitch-based carbon fibers, spherical carbon, and resin-fired carbon. More preferable examples of the carbonaceous material include vapor-grown carbon fibers, mesophase pitch-based carbon fibers, and spherical carbon. The carbonaceous material preferably has lattice spacing d002 between (002) planes of 0.34 nm or less according to X-ray diffraction.

As the metal compound, a metal sulfide, a metal nitride, or the like may be used. As the metal sulfide, for example, titanium sulfide such as TiS₂, for example, molybdenum sulfide such as MoS₂, for example, iron sulfides such as Fes, FeS₂, and LiₓFeS₂ (0≤x≤2) may be used. As the metal nitride, for example, lithium cobalt nitride (for example, LiₓCO_{y}N; 0<x<4, 0<y<0.5) may be used.

Other than the above lithium titanium composite oxides, lithium titanium composite oxides such as monoclinic niobium titanium oxides and orthorhombic titanium-containing composite oxides may be used for the negative electrode active material.

Examples of the monoclinic niobium titanium oxide include a compound represented by LiₐTi₁₋ₓM1ₓNb_{2-y}M₂yO_{7+δ}. Here, M1 is at least one selected from the group consisting of Zr, Si, and Sn. M2 is at least one selected from the group consisting of V, Ta, and Bi. The respective subscripts in the composition formula are specified as follows: 0≤a≤5, 0≤x<1, 0≤y<2, and −0.3≤δ≤0.3. Specific examples of the monoclinic niobium titanium composite oxide include LiₐNb₂TiO₇ (0≤a≤5).

Another example of the monoclinic niobium titanium oxide is a compound represented by LiₐTi₁₋ₓM3_{x+y}Nb_{2-y}O_{7-δ}. Here, M3 is at least one selected from the group consisting of Mg, Fe, Ni, Co, W, Ta, and Mo. The respective subscripts in the composition formula are specified as follows: 0≤a<5, 0<x<1, 0<y<2, and −0.3≤δ≤0.3.

Examples of the orthorhombic titanium-containing composite oxide include a compound represented by Li₂₊ₐM4₂₋ₓTi_{6-y}M5_{z}O_{14+σ}. Here, M4 is at least one selected from the group consisting of Sr, Ba, Ca, Mg, Na, Cs, Rb and K. M5 is at least one selected from the group consisting of Zr, Sn, V, Nb, Ta, Mo, W, Y, Fe, Co, Cr, Mn, Ni and Al. The respective subscripts in the composition formula are specified as follows: 0≤a≤6, 0<x<2, 0≤y<6, 0≤z<6, and −0.5≤σ≤0.5. Specific examples of the orthorhombic titanium-containing composite oxide include Li₂₊ₐNa₂Ti₆O₁₄ (0≤a≤6).

One of the above active materials may be contained in the negative electrode as the negative electrode active material, or two or more thereof may be contained in the negative electrode as the negative electrode active materials.

### <Electro-Conductive Agent>

Examples of the electro-conductive agent include carbonaceous materials such as acetylene black, carbon black, graphite, carbon nanofibers, and carbon nanotubes. These carbonaceous materials may be used alone, or a plurality of the carbonaceous substances may be used.

### <Binder>

Examples of the binder include polytetrafluoroethylene (PTFE), polyvinylidene fluoride (PVdF), fluororubbers, and styrene-butadiene rubber (SBR). In addition, carboxymethyl cellulose (CMC), polyimide, polyamide, and the like may be used as the binder. These binders may be used alone, or a plurality of the binders may be used.

### <Negative Electrode Current Collector>

As the negative electrode current collector, a material that is electrochemically stable at a potential at which the lithium ion insertion-extraction reaction of the negative electrode active material occurs can be used. The negative electrode current collector is preferably a metal foil made of at least one selected from copper, nickel, stainless steel, and aluminum, or an aluminum alloy foil containing at least one selected from the group consisting of Mg, Ti, Zn, Mn, Fe, Cu, and Si.

As the shape of the negative electrode current collector, various shapes can be adopted according to the application of the battery using the negative electrode.

The negative electrode current collector may include a portion that does not support the negative electrode active material-containing layer on the surfaces thereof. This portion can serve as a negative electrode current-collecting tab. Alternatively, the negative electrode may include a current-collecting tab separate from the negative electrode current collector.

### <Production Method>

The negative electrode can be produced by, for example, the following method.

First, the negative electrode active material, the binder, and optionally the electro-conductive agent are suspended in an appropriate solvent to prepare a slurry for producing a negative electrode. As the solvent, for example, a generally used solvent such as N-methylpyrrolidone is used. The obtained slurry is applied onto the negative electrode current collector. The applied slurry is dried and pressed, whereby a negative electrode including a negative electrode current collector and negative electrode active material-containing layer(s) formed on the negative electrode current collector can be obtained. Otherwise, the negative electrode active material, the binder, and optionally the electro-conductive agent may be formed into pellets, and the pellets may be used as the negative electrode active material-containing layer.

### (3) Separator

As the separator, a material having an electrically insulating property is used. The separator is not particularly limited as long as it has an insulating property, and may be, for example, a porous film or nonwoven fabric made of a polymer such as polyolefin, cellulose, polyethylene terephthalate, or vinylon. The materials for the separator may be used alone, or two or more thereof may be used in combination.

### (4) Electrolyte

Examples of the electrolyte include a liquid nonaqueous electrolyte prepared by dissolving an electrolyte salt (solute) in a nonaqueous solvent, a gel nonaqueous electrolyte which is a composite between the liquid nonaqueous electrolyte and a polymeric material, and the like.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium hexalithium antimonate (LiSbF₆), lithium difluoro phosphate (LiPO₂F₂), lithium trifluoromethanesulfonate (LiCF₃SO₃; a.k.a., LiTFS), lithium bistrifluoromethane sulfonylamide (Li(CF₃SO₂)₂N; a.k.a., LiTFSI), lithium bispentafluoroethane sulfonylamide {Li(C₂F₅SO₂)₂N; a. k. a., LiBETI}, lithium bisoxalatoborate {LiB(C₂O₄)₂; a.k.a., LiBOB}, and lithium difluoro (trifluoro-2-oxido-2-trifluoro-methylpropionate (2-)-0, 0) phosphate {LiBF₂OCOOC(CF₃)₂, a. k. a.; LiBF₂(HHIB)}. These electrolyte salts may be used singularly, or alternatively, two or more may be mixed and used. Among them, LiPF₆ and LiBF₄ are particularly preferable.

The electrolyte salt is preferably dissolved within a range of 1 mol/L or more to 3 mol/L or more with respect to the nonaqueous solvent. With an electrolyte salt concentration within this range, performance in a case of flowing a current of high load can be further improved, while suppressing effects of viscosity increase due to raising the electrolyte salt concentration.

The nonaqueous solvent may be an organic solvent, for example, cyclic carbonates such as ethylene carbonate (EC), propylene carbonate (PC), and vinylene carbonate (VC); linear carbonates such as dimethyl carbonate (DMC), ethyl methyl carbonate (EMC), diethyl carbonate (DEC), and dipropyl carbonate (DPC); cyclic ethers such as tetrahydrofuran (THF) and 2-methyl tetrahydrofuran (2-MeTHF); linear ethers such as 1, 2-dimethoxy ethane (1,2-DME); cyclic esters such as γ-butyrolactone (BL); cyclic esters such as methyl acetate, ethyl acetate, methyl propionate, and ethyl propionate; 1, 3-dioxolane; acetonitrile (AN); and sulfolane (SL). These organic solvents may be used singularly or in a form of a mixture of two or more thereof. An organic solvent including a cyclic carbonate and/or a linear carbonate is preferably used.

Examples of the polymeric material used for the gel nonaqueous electrolyte include polyvinylidene fluoride (PVdF), polyacrylonitrile (PAN), polyethylene oxide (PEO), and the like.

### (5) Container Member

The container member may be formed from a laminate film or configured of a container made of a metal. A container made of resin such as polyolefin resin, polyvinyl chloride resin, polystyrene-based resin, acrylic resin, phenol resin, polyphenylene-based resin, and fluorine-based resin may also be used for the container member. When a metal container is used, the lid and container may be a single entity or separate components. A wall thickness of the metal container is desirably 3 mm or less, and more preferably 0.5 mm or less.

Examples of the shape of the container member include a flat shape (thin shape), a prismatic shape, a cylindrical shape, a coin shape, a button shape, a sheet shape, a stacked shape, and the like. The container member may be one for a small-sized battery installed in a portable electronic device and the like, and may also be a container member for a large-sized battery installed on a two-wheeled to four-wheeled automobile.

A wall thickness of the container member made of laminate film is desirably 0.5 mm or less. Examples of the laminate film include a multilayer film including resin layers and a metal layer disposed between the resin layers. The metal layer is preferably made of an aluminum foil or an aluminum alloy foil for the sake of weight reduction. For the resin layers, for example, a film made of a polymer material such as polypropylene (PP), polyethylene (PE), nylon, or polyethylene terephthalate (PET) may be used. The laminate film may be molded into the shape of the container member by thermal sealing.

The metal container is made of aluminum, an aluminum alloy, or the like. The aluminum alloy preferably contains an element such as magnesium, zinc, or silicon. When the alloy contains a transition metal such as iron, copper, nickel, and chromium, the content thereof is preferably 100 ppm or less.

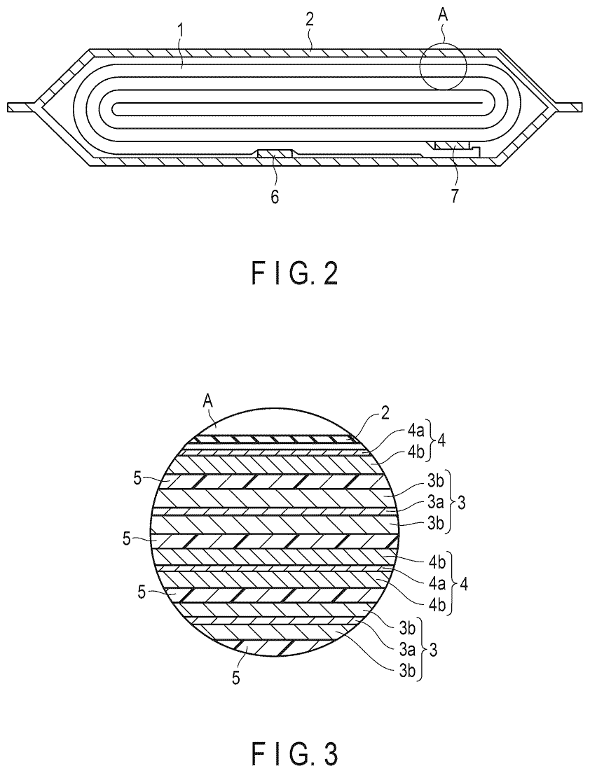

An example of the battery will be described with reference to FIG. 2 and FIG. 3. A flat battery shown in FIG. 2 is provided with a flat shaped wound electrode group 1, a container member 2, a positive electrode terminal 7, a negative electrode terminal 6, and an electrolyte (not shown). The container member 2 is a bag-form container member made of laminate film. The wound electrode group 1 is housed in the container member 2. As shown in FIG. 3, the wound electrode group 1 includes a positive electrode 3, a negative electrode 4 and a separator 5, and is formed by having a stack, with stacking in the order of the negative electrode 4, separator 5, positive electrode 3 and separator 5 from the outside, be spirally wound and subjected to press molding.

The positive electrode 3 includes a positive electrode current collector 3a and positive electrode active material-containing layers 3b. The positive electrode active material-containing layers 3b contain a positive electrode active material. A positive electrode active material-containing layer 3b is formed on both faces of the positive electrode current collector 3a. The negative electrode 4 includes a negative electrode current collector 4a and negative electrode active material-containing layers 4b. The negative electrode active material containing layers 4b contain a negative electrode active material. Among the negative electrode 4, at the portion positioned outermost, a negative electrode active material containing layer 4b is formed only on one face on the inner surface side of the negative electrode current collector 4a. At the other portions of the negative electrode 4, a negative electrode active material containing layer 4b is formed on both faces of the negative electrode current collector 4a.

As shown in FIG. 2, the positive electrode terminal 7 is connected to the positive electrode 3 in vicinity of the outer peripheral end of the wound electrode group 1. The negative electrode terminal 6 is connected to the negative electrode 4 at the outermost portion. The positive electrode terminal 7 and the negative electrode terminal 6 are extended to the outside through an opening of the container member 2.

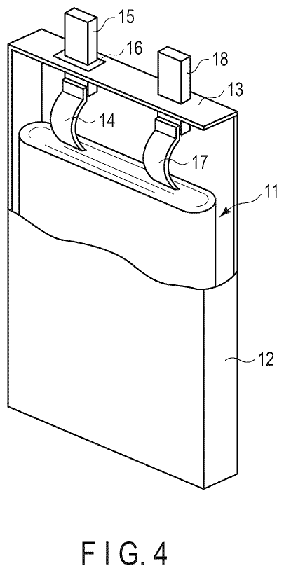

The battery is not limited to one having the configuration shown in FIG. 2 and FIG. 3 described above, but may be of a configuration shown in FIG. 4, for example.

In a prismatic battery shown in FIG. 4, a wound electrode group 11 is housed in a bottomed rectangular tubular container 12 made of metal as the container member. A rectangular lid 13 is welded to the opening of the container 12. The flat wound electrode group 11 may have, for example, a configuration similar to the wound electrode group 1 described with reference to FIG. 2 and FIG. 3.

One end of a negative electrode current collecting tab 14 is electrically connected to the negative electrode current collector and the other end thereof is electrically connected to a negative electrode terminal 15. The negative electrode terminal 15 is fixed to the rectangular lid 13 by a hermetic seal with a glass material 16 interposed. One end of a positive electrode current collecting tab 17 is electrically connected to the positive electrode current collector and the other end is electrically connected to a positive electrode terminal 18 fixed to the rectangular lid 13.

The negative electrode current collecting tab 14 is made of a material such as aluminum or an aluminum alloy containing elements such as Mg, Ti, Zn, Mn, Fe, Cu, Si, and the like. The negative electrode current collecting tab 14 is preferably formed of the same material as that of the negative electrode current collector, so as to reduce the contact resistance with the negative electrode current collector.

The positive electrode current collecting tab 17 is made of a material such as aluminum or an aluminum alloy containing elements such as Mg, Ti, Zn, Mn, Fe, Cu, Si, and the like. The positive electrode current collecting tab 17 is preferably formed of the same material as that of the positive electrode current collector, so as to reduce the contact resistance with the positive electrode current collector.

In the illustrated battery, the wound electrode group in which the separator is wound together with the positive electrode and the negative electrode has been used, but there may be used a stacked electrode group in which positive electrodes and negative electrodes are alternately stacked with the separator(s) interposed therebetween.

The battery according to the second embodiment includes the battery according to the first embodiment. Therefore, the battery is excellent in capacity retention ratio and the resistance increase thereof is suppressed, and thus, the battery exhibits excellent life performance.

### Third Embodiment

According to a third embodiment, a battery pack is provided. The battery pack includes the battery according to the second embodiment.

The battery pack according to the third embodiment may include one or plural of the battery (single-battery) according to the second embodiment described above. The plural batteries that may be included in the battery pack may be electrically connected in series or in parallel to configure a battery module. The battery pack may include plural battery modules.

Next, an example of a battery pack according to the third embodiment will be described with reference to the drawings.

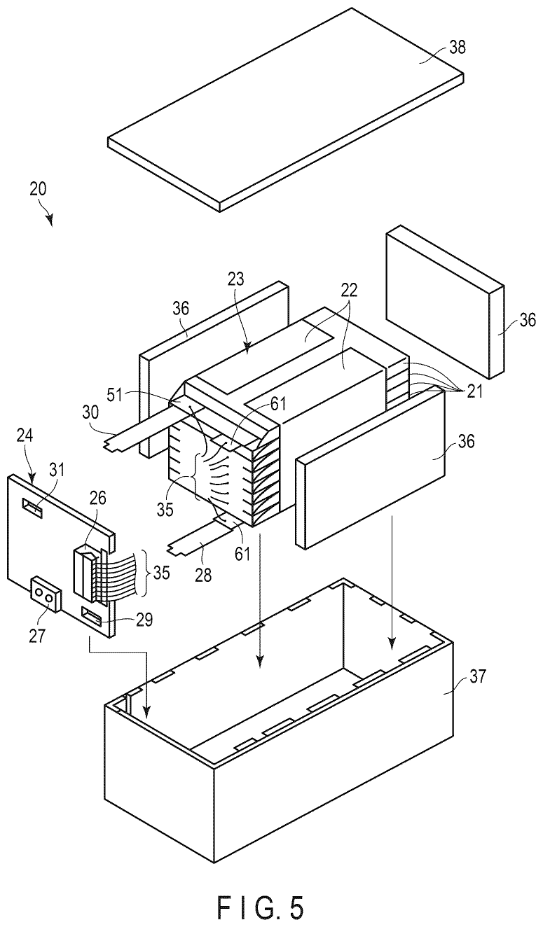

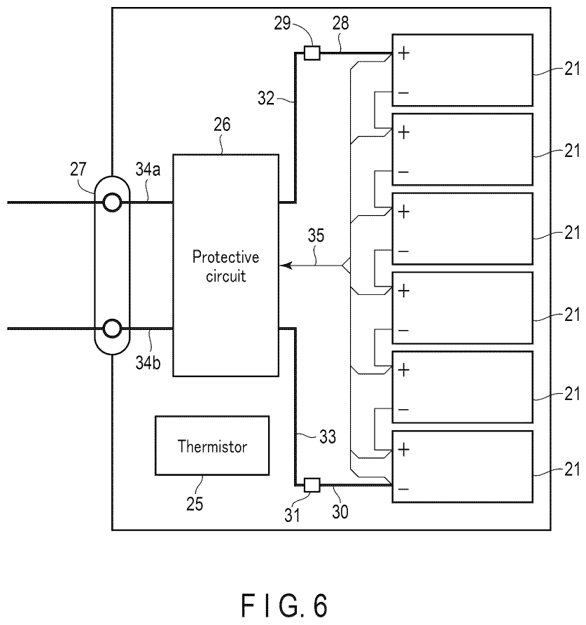

FIG. 5 is an exploded perspective view of an example of the battery pack according to the second embodiment. FIG. 6 is a block diagram showing an electric circuit of the battery pack shown in FIG. 6.

The battery pack 20 shown in FIG. 5 and FIG. 6 includes plural single-batteries 21. The single-battery 21 may be the exemplar flat battery according to the second embodiment described with reference to FIG. 4.

The plural single-batteries 21 are stacked so that negative electrode terminals 51 and positive electrode terminals 61 extending outside are aligned in the same direction and are fastened with an adhesive tape 22 to configure a battery module 23. These single-batteries 21 are electrically connected in series with each other as shown in FIG. 6.

A printed wiring board 24 is disposed facing the side surface from which the negative electrode terminals 51 and the positive electrode terminals 61 of the single-batteries 21 extend. As shown in FIG. 6, the printed wiring board 24 is installed with a thermistor 25, a protective circuit 26, and an energizing terminal 27 to external equipment. Note that an insulating plate (not shown) is attached to the surface of the printed wiring board 24 which faces the battery module 23 so as to avoid unnecessary connection with the wiring of the battery module 23.

A positive electrode side lead 28 is connected to the positive electrode terminal 61 located lowermost in the battery module 23, and its tip is inserted into a positive electrode side connector 29 of the printed wiring board 24 and electrically connected thereto. A negative electrode side lead 30 is connected to the negative electrode terminal 51 located uppermost in the battery module 23, and its tip is inserted into the negative electrode side connector 31 of the printed wiring board 24 and electrically connected thereto. These connectors 29 and 31 are connected to the protective circuit 26 through wiring 32 and the wiring 33 formed on the printed wiring board 24.

The thermistor 25 detects the temperature of the single-batteries 21, and the detection signal is transmitted to the protective circuit 26. The protective circuit 26 can shut off a plus-side wiring 34a and a minus-side wiring 34b between the protective circuit 26 and the energizing terminal 27 to external equipment in accordance to a predetermined condition. An example of the predetermined condition is, for example, when the temperature detected by the thermistor 25 becomes a predetermined temperature or higher. Another example of the predetermined condition is, for example, when overcharge, over-discharge, overcurrent, or the like of the single-battery 21 is detected. Detection of the overcharge or the like is performed for each of the individual single-batteries 21 or the entire battery module 23. In the case of detecting each single-battery 21, a battery voltage may be detected, or a positive electrode potential or a negative electrode potential may be detected. In the latter case, a lithium electrode used as a reference electrode is inserted into each single-battery 21. In the case of the battery pack 20 of FIG. 5 and FIG. 6, wiring 35 for voltage detection is connected to each of the single-batteries 21. Detection signals are transmitted to the protective circuit 26 through the wiring 35.

Protective sheets 36 made of rubber or resin are respectively arranged on three side surfaces of the battery module 23 excluding the side surface from which the positive electrode terminal 61 and the negative electrode terminal 51 protrude.

The battery module 23 is housed in a housing container 37 together with each protective sheet 36 and the printed wiring board 24. That is, the protective sheets 36 are disposed in the housing container 37 respectively on both inner side surfaces in a long-side direction and the inner side surface in a short-side direction, and the printed wiring board 24 is disposed on the inner side surface at the opposite side in the short-side direction. The battery module 23 is located in a space surrounded by the protective sheets 36 and the printed wiring board 24. A lid 38 is attached to the upper surface of the housing container 37.

For fixing the battery module 23, a thermal shrinkage tape may be used in place of an adhesive tape 22. In this case, after the protective sheets are disposed on each side surface of the battery module and a thermal shrinkage tape is wound, the thermal shrinkage tape is thermally shrunk, to bind the battery module.

In FIG. 5 and FIG. 6, the single-batteries 21 are connected in series, but the single-batteries 21 may be connected in parallel in order to increase the battery capacity. Further, assembled battery packs may also be connected in series and/or parallel.

The mode of the battery pack is appropriately changed depending on the application. A preferable application of the battery pack is one where good cycle performance is desired when a large current is extracted. Specific examples of the applications include that for a power source of a digital camera, and for use in a vehicle such as a two-wheeled to four-wheeled hybrid electric automobile, a two-wheeled to four-wheeled electric automobile, and a power-assisted bicycle. The battery pack is particularly favorably used for onboard use.

The battery pack according to the third embodiment includes the battery according to the second embodiment. Therefore, the battery pack is excellent in capacity retention ratio and the resistance increase thereof is suppressed, and thus, the battery pack exhibits excellent life performance.

### EXAMPLES

The present invention will be described in more detail with reference to examples described below, but the invention is not limited to the examples listed below, as long as the spirit of the invention is not exceeded.

### Example 1

### <Production of Positive Electrode>

Lithium nickel cobalt manganese composite oxide LiNi_{0.8}CO_{0.1}Mn_{0.1}O₂ having an average primary particle diameter of 5.0 μm was prepared as a positive electrode active material, acetylene black (AB) was prepared as a first electro-conductive agent, flake graphite (FG) was prepared as a second electro-conductive agent, and a polymeric polyvinylidene fluoride (PVdF) having a modified group was prepared as a binder. The prepared materials were mixed in N-methylpyrrolidone to obtain a slurry for producing a positive electrode. The relative masses of the positive electrode active material, first electro-conductive agent, second electro-conductive agent, and binder added in N-methylpyrrolidone were 89 parts by mass, 3.3 parts by mass, 3.7 parts by mass, and 4 parts by mass, respectively. The obtained slurry was applied onto both surfaces of an aluminum foil (current collector) having a band shape and a thickness of 12 μm so that the application amount per unit area was 80 g/m², and dried. Upon application, a part of the aluminum foil was kept uncoated to form a current-collecting tab. A dryer of 10 m in length was used for drying, and the aluminum foil was conveyed at a speed of 10 m/min in performing the drying. The obtained coating film was pressed along with the current collector so as to obtain an active material-containing layer having a thickness of 25 μm per surface. In this manner, a positive electrode was produced.

### <Production of Negative Electrode>

Spinel lithium titanate Li₄Ti₅O₁₂ was prepared as a negative electrode active material, flake graphite was prepared as an electro-conductive agent, and PVdF was prepared as a binder. The prepared materials were mixed in N-methylpyrrolidone to obtain a slurry for producing a negative electrode. The relative masses of the negative electrode active material, electro-conductive agent, and binder added in N-methylpyrrolidone were 95 mass %, 2.5 mass %, and 2.5 mass %, respectively. The prepared slurry for producing the negative electrode was applied onto both surfaces of an aluminum foil (current collector) having a band shape and a thickness of 12 μm so that the application amount per unit area was 100 g/m², and dried. Upon application, a part of the aluminum foil was kept uncoated to form a current-collecting tab. The coating film obtained was pressed along with the current collector so as to obtain an active material-containing layer having a density of 2.5 g/cm³. In this manner, a negative electrode was produced.

### <Production of Electrode Group>

The positive electrode and negative electrode produced as described above were stacked with a separator having a thickness of 10 μm interposed therebetween. The obtained stack was wound so that the negative electrode was positioned outermost. The electrode group obtained by winding was pressed while heating to 80° C., and fixed with an insulating tape. In this manner, a flat-shaped wound electrode group having a positive electrode, a negative electrode, and a separator positioned between the positive electrode and the negative electrode was obtained.

### <Preparation of Nonaqueous Electrolyte>

Propylene carbonate (PC) and diethyl carbonate (DEC) were mixed at a volume ratio of 1:1, to thereby prepare a nonaqueous solvent. Lithium hexafluorophosphate LiPF₆ was dissolved in the obtained nonaqueous solvent at a concentration of 1.0 mol/L, thereby preparing a nonaqueous electrolyte.

### <Assembly of Battery>

The electrode group formed into a flat shape that had been obtained as explained above was inserted into a can formed of aluminum with a plate thickness of 0.3 mm having a bottomed rectangular tube shape. The opening of the can was sealed with a sealing plate, to thereby house the electrode group in the can as the container member. The nonaqueous electrolyte prepared as described above was poured into the container through an electrolytic solution inlet provided on the sealing plate. Next, a sealing lid was welded to the periphery of the electrolytic solution inlet, to thereby prepare a flat nonaqueous electrolyte secondary battery.

### Examples 2 to 4

In Examples 2 to 4, batteries were produced in the same manner as in Example 1 except that the blending amounts of acetylene black (AB) and flake graphite (FG) used for the first and second electro-conductive agents of the positive electrode were changed to those shown in Table 2, from those of Example 1. The pressability of the coating film of the slurry for producing the positive electrode was changed due to the change in the blending amount of the electro-conductive agents, and the thickness of the positive electrode active material-containing layer per surface of the current collector had changed to the values shown in Table 2.

### Example 5

In Example 5, a battery was produced in the same manner as in Example 1 except that the blending amounts of AB and FG used for the positive electrode were changed to those shown in Table 2, from those of Example 1, and the design of the positive electrode active material-containing layer was changed to that shown in Tables 1 and 2, from that of Example 1, by controlling the dispersion condition of the slurry for producing the positive electrode and the press load for the active material-containing layer. For the design of the positive electrode active material-containing layer, the pore specific surface area S_{Hg} according to a mercury intrusion method, the specific surface area S_{BET} according to a nitrogen gas adsorption method (BET method), and the thickness of the positive electrode active material-containing layer per surface of the current collector were adjusted, as shown in Tables 1 and 2.

### Examples 6 and 7

In Examples 6 and 7, batteries were produced in the same manner as in Example 1 except that the application amount of the slurry for producing the positive electrode onto the current collector was changed from that of Example 1. A positive electrode active material-containing layer having a thickness per surface of the current collector shown in Table 2 was obtained due to the change in the application amount of the slurry for producing the positive electrode.

### Comparative Example 1

In Comparative Example 1, a battery was produced in the same manner as in Example 1 except that the blending amounts of AB and FG used for the positive electrode were changed to those shown in Table 2, from those of Example 1, and the design of the positive electrode active material-containing layer were changed to that shown in Tables 1 and 2, from those of Example 1, by controlling the dispersion condition of the slurry for producing a positive electrode and the press load of the active material-containing layer.

### Comparative Example 2

In Comparative Example 2, a battery was produced in the same manner as in Example 1 except that a carbon nanotube (CNT) was used in place of FG as the electro-conductive agent of the positive electrode, and the blending amount thereof and the blending amount of AB were changed to those shown in Table 2, from those of Example 1.

### Comparative Example 3

In Comparative Example 3, a battery was produced in the same manner as in Example 1 except that the application amount of the slurry for producing the positive electrode onto the current collector was significantly increased, as compared with Example 1. A positive electrode active material-containing layer having a thickness per surface of the current collector shown in Table 2 was obtained due to the change in the application amount of the slurry for producing the positive electrode.

### Comparative Examples 4 and 5

In Comparative Examples 4 and 5, batteries were produced in the same manner as in Example 1 except that the blending amounts of AB and FG used for the positive electrode were changed to those as shown in Table 2, from those of Example 1.

The following Tables 1 and 2 summarize the design of the positive electrode active material-containing layer in each of the Examples and Comparative Examples. As the design of the active material-containing layer, the specific surface area S_{BET} measured by the nitrogen gas adsorption method (BET method) described above, the pore specific surface area S_{Hg} measured by the mercury intrusion method described above, and the ratio S_{BET}/S_{Hg} thereof are shown in Table 1. Table 2 shows the parts by mass of the first and second electro-conductive agents used for the positive electrode active material-containing layer, the volume resistivity R_{V} of the positive electrode active material-containing layer measured by the method described above, the interfacial resistivity R_{I} between the positive electrode active material-containing layer and the positive electrode current collector measured by the method described above, the ratio R_{V}/R_{I} thereof, and the thickness of the positive electrode active material-containing layer per surface of the current collector.

TABLE 1

| | Positive electrode | | |
|---|---|---|---|
| | active material-containing layer | | |
| | S_{BET} | S_{Hg} | S_{BET}/S_{Hg} |
| Example 1 | 2.9 | 2.8 | 1.0 |
| Example 2 | 2.9 | 2.8 | 1.0 |
| Example 3 | 2.9 | 2.8 | 1.0 |
| Example 4 | 2.9 | 2.8 | 1.0 |
| Example 5 | 4.0 | 2.5 | 1.6 |
| Example 6 | 2.9 | 2.8 | 1.0 |
| Example 7 | 2.9 | 2.8 | 1.0 |
| Comparative | 4.83 | 2.3 | 2.1 |
| Example 1 | | | |
| Comparative | 2.9 | 2.8 | 1.0 |
| Example 2 | | | |
| Comparative | 2.9 | 2.8 | 1.0 |
| Example 3 | | | |
| Comparative | 2.9 | 2.8 | 1.0 |
| Example 4 | | | |
| Comparative | 2.9 | 2.8 | 1.0 |
| Example 5 | | | |

TABLE 2

| | Positive electrode | | | | | |
|---|---|---|---|---|---|---|
| | | | | Interfacial | | |
| | | | | resistivity R_{I} | | |
| | | | Volume | between | | |
| | | | resistivity R_{V} | active | | |
| | First | Second | of | material- | | Thickness of |
| | electro- | electro- | active | containing | | active |
| | conductive | conductive | material- | layer | Resistivity | material- |
| | agent/ | agent/ | containing | and current | ratio | containing |
| | parts by | parts by | layer | collector | R_{V}/R_{I} | layer |
| | mass | mass | [Ω · cm] | [Ω · cm²] | [cm⁻¹] | [μm] |
| Example 1 | AB/3.3 | FG/3.7 | 2.65 | 0.19 | 13.7 | 25 |
| Example 2 | AB/3.3 | FG/4.0 | 2.52 | 0.20 | 12.6 | 27 |
| Example 3 | AB/4.0 | FG/3.5 | 2.12 | 0.11 | 19.3 | 31 |
| Example 4 | AB/2.5 | FG/10.0 | 1.25 | 0.30 | 4.2 | 38 |
| Example 5 | AB/2.5 | FG/3.5 | 2.32 | 0.14 | 16.6 | 23 |
| Example 6 | AB/3.3 | FG/3.7 | 3.51 | 0.21 | 16.7 | 52 |
| Example 7 | AB/3.3 | FG/3.7 | 1.13 | 0.08 | 14.1 | 13 |
| Comparative | AB/3.0 | FG/5.5 | 1.53 | 0.08 | 19.1 | 32 |
| Example 1 | | | | | | |
| Comparative | AB/2.0 | CNT/1.0 | 1.28 | 0.007 | 182 | 23 |
| Example 2 | | | | | | |
| Comparative | AB/3.0 | FG/6.0 | 4.0 | 0.57 | 7.0 | 70 |
| Example 3 | | | | | | |
| Comparative | AB/1.0 | FG/3.0 | 3.21 | 1.62 | 2.1 | 22 |
| Example 4 | | | | | | |
| Comparative | AB/3.0 | FG/2.0 | 5.45 | 0.23 | 24.1 | 23 |
| Example 5 | | | | | | |

### <Cycle Test>

For each of the produced batteries, a cycle test was performed as follows.

First, the battery was charged at a current value of 1C in a 25° C. environment up to a state of charge (SOC) of 100%. Thereafter, the battery was discharged to an SOC of 0% at a current value of 0.2C, and the discharge capacity at that time was measured. Subsequently, the battery was charged to an SOC of 50% at a current value of 1C, and a charge resistance value (unit: mΩ) at that time was measured.

Then, 2000 cycles of a charge and discharge cycle where a battery was charged at a 3C rate in a 25° C. environment up to a state of charge (SOC) of 100% and discharged at a 3C rate down to an SOC of 0% were performed. After the discharge at the 2000th cycle was performed, the discharge capacity and the charge resistance value after the 2000 cycles were measured again by the same procedure as the measurement of the discharge capacity and the electric resistance before the charge and discharge cycles were performed.

From the discharge capacity before and after 2000 cycles of charge and discharge, the capacity retention ratio was calculated using the following formula:

Capacity retention ratio (unit: %)=[discharge capacity after carrying out cycles/discharge capacity before carrying out cycles]×100%. From the discharge resistance values before and after 2000 cycles of charge and discharge, the resistance increase ratio was calculated using the following formula:

$$Resistance increase ratio ( unit : \% ) = [ charge resistance value after carrying out cycles / charge resistance value before carrying out cycles ] \times 100 \% .$$

The calculated results are shown in Table 3 below.

TABLE 3

Nonaqueous electrolyte
secondary battery

| | Capacity retention | Resistance increase |
|---|---|---|
| | ratio | ratio |
| | [%] | [%] |
| Example 1 | 99 | 112 |
| Example 2 | 99 | 110 |
| Example 3 | 97 | 108 |
| Example 4 | 96 | 105 |
| Example 5 | 95 | 105 |
| Example 6 | 96 | 114 |
| Example 7 | 99 | 102 |
| Comparative | 87 | 105 |
| Example 1 | | |
| Comparative | 89 | 103 |
| Example 2 | | |
| Comparative | 92 | 140 |
| Example 3 | | |
| Comparative | 93 | 205 |
| Example 4 | | |
| Comparative | 98 | 120 |
| Example 5 | | |

From Table 3, the batteries produced in Examples 1 to 7 are found to have achieved both excellent capacity retention ratio and suppression of resistance increase. In contrast, in Comparative Examples 1 to 5, either one or both of the capacity retention ratio and the suppression of resistance increase are found to be inferior compared to those of Examples 1 to 7. In Examples 1 to 7, a uniform electrical resistance was achieved in the positive electrode active material-containing layer using the single crystal nickel cobalt manganese composite oxide and satisfying the above-described ratio 0.8<S_{BET}/S_{Hg}<2.0 of the pore specific surface area and the pore volume, such that the ratio of the volume resistance R_{V} of the active material-containing layer itself to the interfacial resistance R_{I} between the active material-containing layer and the current collector satisfies 3 cm⁻¹≤R_{V}/R_{I}≤20 cm⁻¹. Thereby, the permeability of the electrolytic solution into the positive electrode active material-containing layer and the electrode reaction area were appropriately controlled, and at the same time, local deterioration of the positive electrode active material-containing layer was able to be suppressed.

In contrast, in the batteries of Comparative Examples 1 to 5, the positive electrode active material-containing layer did not satisfy some of the above conditions, and either one or both of the capacity retention ratio and the suppression of resistance increase were inferior as compared to those of Examples 1 to 7.

Specifically, in Comparative Example 1, the ratio of S_{BET} to S_{Hg} was 2.1. Thus, it can be seen that the positive electrode active material obtained in Comparative Example 1 had many micropores, and polycrystals had formed secondary particles. In Comparative Example 1, the capacity retention rate was significantly low. It was confirmed that performance deterioration had progressed by side reactions between the positive electrode and the electrolytic solution, due to the large specific surface area of the polycrystalline positive electrode active material.

In Comparative Example 2, a carbon nanotube (CNT) was used as the second electro-conductive agent for the positive electrode in place of flake graphite. Since CNT has a fibrous shape, it can connect active material particles within the active material-containing layer to form a wide electrically conductive path in a manner similar to flake graphite, so thus, the volume resistivity R_{V} of the active material-containing layer is decreased. However, at the same time, CNT can enter fine gaps between active materials in a manner similar to acetylene black, with the result that the interfacial resistance R_{I} between the active material-containing layer and the current collector was also greatly reduced, and the R_{V}/R_{I} ratio significantly increased. As a result, the electrical current within the positive electrode active material-containing layer had tended to flow more toward the side of the interface with the current collector, and charging and discharging were performed nonuniformly within the active material-containing layer, reducing the capacity retention ratio.

In Comparative Example 3, the application amount of the slurry for forming the thick positive electrode active material-containing layer was great, and thus a strong effect of binder migration during a slurry drying process is reflected in a significant increase in interfacial resistance R_{I} between the active material-containing layer and the current collector. Specifically, acetylene black did not remain in the vicinity of the interface, and the interfacial resistance R_{I} increased. Since the interfacial resistance was high, it was difficult for a current to flow from the current collector to the positive electrode active material-containing layer, and the deterioration of the active material-containing layer proceeded during the charging and discharging process, leading to unfavorable results in terms of both the capacity retention ratio and the resistance increase ratio.

In Comparative Example 4, since the blending amount of acetylene black added to the positive electrode was low, the interfacial resistance R_{I} increased, and the Ry/R_{I} ratio was less than 3 cm⁻¹. Thus, in Comparative Example 4, as well, it was difficult for current to flow from the current collector to the positive electrode active material-containing layer, and the deterioration of the active material-containing layer proceeded during the charging and discharging process, making both the capacity retention rate and the resistance increase ratio unfavorable.

In Comparative Example 5, since the blending amount of the flake graphite added to the positive electrode was low, the volume resistivity R_{V} of the active material-containing layer increased, and the R_{V}/R_{I} ratio was beyond 20 cm⁻¹. Accordingly, it was difficult for current to flow to the positive electrode active material-containing layer, and the current was concentrated in the vicinity of the interface with the current collector. As a result of local deterioration of the electrode member in the vicinity of the interface, the resistance increase ratio rose.

According to at least one embodiment and example described above, an electrode is provided. The electrode includes an active material-containing layer that contains lithium nickel cobalt manganese composite oxide as an active material and a current collector. In the active material-containing layer, a specific surface area S_{BET} according to a nitrogen gas adsorption method and a pore specific surface area S_{Hg} according to a mercury intrusion method satisfy a relationship of 0.8<S_{BET}/S_{Hg}<2.0, and a volume resistivity R_{V} of the active material-containing layer of 10 Ω·cm or less and an interfacial resistance R_{I} of an interface between the current collector and the active material-containing layer of 0.5 Ω·cm² or less satisfy a relationship of 3 cm⁻¹≤R_{V}/R_{I}≤20 cm⁻¹. The above electrode can provide a battery and battery pack excellent in life performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinafter, several embodiments of the invention will be described.

1. An electrode comprising:
a current collector;
an active material-containing layer on the current collector, the active material-containing layer containing an active material and an electro-conductive agent,
the active material including a lithium nickel cobalt manganese composite oxide,
a specific surface area S_{BET} of the active material-containing layer according to a nitrogen gas adsorption method and a pore specific surface area S_{Hg} of the active material-containing layer according to a mercury intrusion method satisfying a relationship of 0.8<S_{BET}/S_{Hg}<2.0, and
a volume resistivity R_{V} of the active material-containing layer being 10 Ω·cm or less, an interfacial resistance R_{I} of an interface between the current collector and the active material-containing layer being 0.5 Q. cm² or less, and a ratio R_{V}/R_{I} of the volume resistivity R_{V} to the interfacial resistance R_{I} being 3 cm⁻¹ or more and 20 cm⁻¹ or less.

2. The electrode according to clause 1, wherein the electro-conductive agent comprises at least flake graphite, and a content of the flake graphite in the active material-containing layer is 3 mass % or more relative to a mass of the active material-containing layer.

3. The electrode according to clause 1 or 2, wherein the active material-containing layer has a thickness of 10 μm or more and 60 μm or less.

4. The electrode according to any one of clauses 1 to 3,
wherein the active material includes a compound represented by LiₐNi_{(1-b-c-d)}CO_{b}Mn_{c}M_{d}O₂, where 1<a≤1.2, 0≤b≤0.4, 0≤c≤0.4, and 0≤d≤0.1, and M includes at least one selected from the group consisting of Fe, Cu, Ti, Mg, Al, W, Y, B, Mo, Nb, Zn, Sn, Zr, Ga, and V.

5. A battery comprising:
the electrode according to any one of clauses 1 to 4; and
an electrolyte.

6. A battery pack comprising the battery according to clause 5.

What is claimed is:

1. An electrode comprising:
a current collector;
an active material-containing layer on the current collector, the active material-containing layer containing an active material and an electro-conductive agent,
the active material comprising a lithium nickel cobalt manganese composite oxide,
a specific surface area S_{BET} of the active material-containing layer according to a nitrogen gas adsorption method and a pore specific surface area S_{Hg} of the active material-containing layer according to a mercury intrusion method satisfying a relationship of 0.8<S_{BET}/S_{Hg}<2.0, and
a volume resistivity R_{V} of the active material-containing layer being 10 Ω·cm or less, an interfacial resistance R_{I} of an interface between the current collector and the active material-containing layer being 0.5 Ω·cm² or less, and a ratio R_{V}/R_{I} of the volume resistivity R_{V} to the interfacial resistance R_{I} being 3 cm⁻¹ or more and 20 cm⁻¹ or less.

2. The electrode according to claim 1, wherein the electro-conductive agent comprises at least flake graphite, and a content of the flake graphite in the active material-containing layer is 3 mass or more relative to a mass of the active material-containing layer.

3. The electrode according to claim 1, wherein the active material-containing layer has a thickness of 10 μm or more and 60 μm or less.

4. The electrode according to claim 1,
wherein the active material includes a compound represented by LiₐNi_{(1-b-c-d)}CO_{b}Mn_{c}M_{d}O₂, where 1<a≤1.2, 0≤b≤0.4, 0≤c≤0.4, and 0≤d≤0.1, and M includes at least one selected from the group consisting of Fe, Cu, Ti, Mg, Al, W, Y, B, Mo, Nb, Zn, Sn, Zr, Ga, and V.

5. A battery comprising:
the electrode according to claim 1; and
an electrolyte.

6. A battery pack comprising the battery according to claim 5.
